(19) United States
(12) Patent Application Publication
(10) Pub. No.: US 2013/0145182 A1
(43) Pub. Date: Jun. 6, 2013

(54) POWER SUPPLY DEVICE FOR SERVER SYSTEMS

(71) Applicants: YU-CHI TSAI, Tu-Cheng (TW); KUEI-CHIH HOU, Tu-Cheng (TW)

(72) Inventors: YU-CHI TSAI, Tu-Cheng (TW); KUEI-CHIH HOU, Tu-Cheng (TW)

(73) Assignee: HON HAI PRECISION INDUSTRY CO., LTD., Tu-Cheng (TW)

(21) Appl. No.: 13/585,760

(22) Filed: Aug. 14, 2012

(30) Foreign Application Priority Data
Dec. 5, 2011 (TW) 100144735

(51) Int. Cl. G06F 1/26

(52) U.S. Cl. 713/300

(57) ABSTRACT

A power supply device for a server system includes a main power supply, a control microchip, a first switch, a trigger, a second switch, and an auxiliary power supply. When a voltage of the main power supply is within a predetermined range, the control microchip keeps the first switch turned off and the trigger keeps the second switch turned on, so that a voltage of the auxiliary power supply is transmitted to the server system via the second switch. When the main power supply is outside the predetermined range, the control microchip turns on the first switch and the trigger turns off the second switch, so that the voltage of the auxiliary power supply is transmitted to ground.

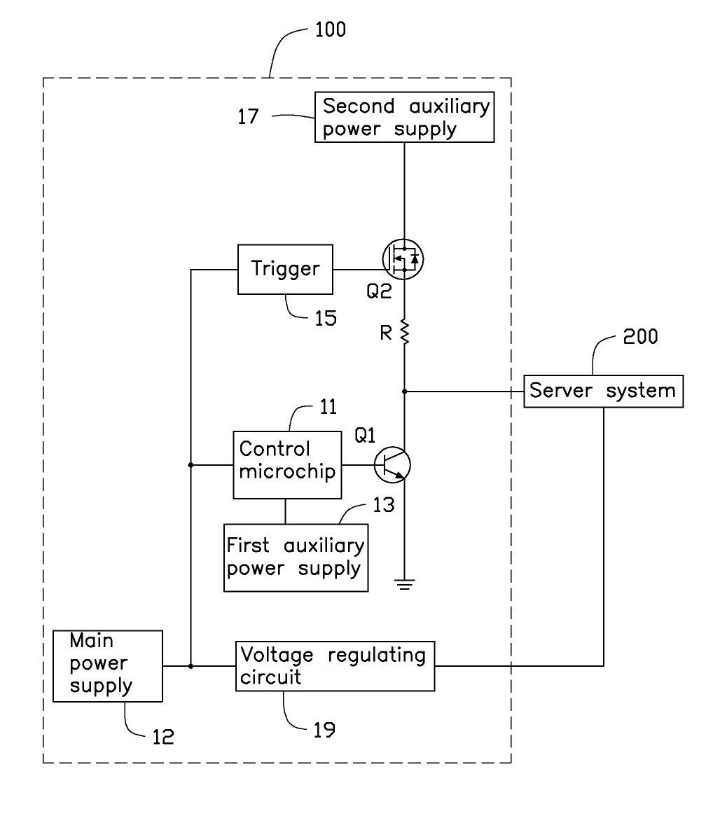

### BACKGROUND

1. Technical Field

The present disclosure relates to power supply devices, and particularly to a power supply device for server systems.

2. Description of Related Art

A central processing unit (CPU) of a server system can continuously detect a power supply of the server system and identify a working status of the power supply. If the CPU determines that the power supply is malfunctioning or that the power level of the power supply is low, the CPU can timely store currently processed data of the server system and turn off the power supply.

A power supply detector of the server system generally informs the CPU of the server system about a normal working status of the power supply by sending an indication signal to the CPU. If the CPU detects that a voltage of the indication signal is outside of a predetermined range, the CPU determines that the power supply is malfunctioning or that the power being supplied is too low. However, in actual use, the indication signal may be corrupted by other electronic elements of the server system, which may cause the CPU to mistakenly determine the working status of the power supply. Thus, the power supply may be mistakenly turned off when it is in fact working normally, or not be turned off in a timely manner when it ought to be.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

The FIGURE is a circuit diagram of a power supply device, according to an exemplary embodiment, for a server system.

### DETAILED DESCRIPTION

The FIGURE shows a circuit diagram of a power supply device 100, according to an exemplary embodiment. The power supply device 100 can supply electrical power to a server system 200, and can further inform the server system 200 about a working status of the power supply device 100.

The power supply device 100 includes a control microchip 11, a main power supply 12, a first auxiliary power supply 13, a trigger 15, a second auxiliary power supply 17, a voltage regulating circuit 19, a first switch Q1, a second switch Q2, and a resistor R. The main power supply 12 can be a wall socket, a battery, or other power supply. The main power supply 12 is electrically connected to the server system 200 via the voltage regulating circuit 19. The voltage regulating circuit 19 can regulate an output voltage of the main power supply 12 to a power supply voltage having a predetermined value, and transmit the regulated power to the server system 200.

Both the control microchip 11 and the trigger 15 are electrically connected to the main power supply 12 to detect the output voltage of the main power supply 12. The first auxiliary power supply 13 is electrically connected to the control microchip 11 to supply electric power to the control microchip 11.

The first switch Q1 is a transistor that includes a base, an emitter, and a collector (not labeled), and the second switch Q2 is a metal-oxide-semiconductor field-effect transistor (MOSFET) that includes a gate, a source, and a drain (not labeled). The base of the first switch Q1 is electrically connected to the control microchip 11, the emitter of the first switch Q1 is grounded, and the collector of the first switch Q1 is electrically connected to the source of the second switch Q2 via the resistor R. The server system 200 is electrically connected between the resistor R and the collector of the first switch Q1. The gate of the second switch Q2 is electrically connected to the trigger 15. The drain of the second switch Q2 is electrically connected to the second auxiliary power supply 17.

In use, the voltage regulating circuit 19 regulates the output voltage of the main power supply 12 to the power supply voltage having the predetermined value, and transmit the power supply voltage to the server system 200 to supply electric power to the server system 200.

When supplying electrical power, the control microchip 11 and the trigger 13 continuously detect the output voltage of the main power supply 12. As long as the output voltage of the main power supply 12 is within a predetermined range of what is acceptable, the control microchip 11 determines that the main power supply 12 is working normally and keeps the first switch Q1 off. In the same circumstance, the trigger 15 keeps the second switch Q2 on. Thus, a voltage of the second auxiliary power supply 17 is transmitted to the server system 200 via the drain and the source of the second switch Q2 and the resistor R, and forms a relatively higher indication voltage received by the server system 200. As long as the relatively higher indication voltage is being received, the server system 200 determines that the main power supply 12 is working normally, and maintains the current working processes.

If the control microchip 11 detects that the output voltage of the main power supply 12 exceeds the acceptable range, or that the main power supply 12 is fluctuating, or is below the acceptable range, the control microchip 11 turns on the first switch Q1. At the same time, in any of these circumstances, the trigger 15 turns off the second switch Q2. In this way, the voltage of the second auxiliary power supply 17 cannot be passed to the server system 200, and the server system 200 receives an indication of a relatively lower voltage. Thus, the server system 200 determines that the main power supply is malfunctioning or that the power level of the main power supply 12 is too low. The server system 200 can thus complete the processing of current data, and actuate protection actions (e.g., disconnecting from the power supply device 100) to prevent damage or loss caused by an abnormal power supply from the power supply device 100.

When using the power supply device 100, the server system 200 receives the indication voltages generated between the resistor R and the collector of the first switch Q1 as a means of detecting the working status of the main power supply 12. When the main power supply 12 works normally, the first switch Q1 is turned off and is prevented from interfering with the indication voltages. When the main power supply 12 is too low or too unstable to keep the second switch Q2 turned on, the second switch Q2 is turned off, and thus the second auxiliary power supply 17 is prevented from interfering with the indication voltages. In this way, the indications as to the working status of the main power supply 12 at any moment can be faithfully reported to the server system 200.

In the power supply device 100, when the main power supply 12 works normally, the control microchip 11 can use power of the main power supply 12 to work itself. When the main power supply 12 malfunctions or loses power, the control microchip 11 can use power of the first auxiliary power supply 13 as its own power supply.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A power supply device for a server system, comprising:
a main power supply electrically connected to the server system to supply power to the server system;
a control microchip electrically connected to the main power supply;
a first switch electrically connected to the control microchip;
a trigger electrically connected to the main power supply;
a second switch electrically connected to the trigger; and
an auxiliary power supply electrically connected to a ground via the second switch and the first switch electrically connected in series;
wherein the server system is electrically connected between the second switch and the first switch; and in response to a voltage of the main power supply being within a predetermined range, the control microchip turns off the first switch and the trigger turns on the second switch, so that a voltage of the auxiliary power supply is transmitted to the server system via the second switch; and in response to the voltage of the main power supply exceeding the predetermined range, the control microchip turns on the first switch and the trigger turns off the second switch, so that the voltage of the auxiliary power supply is transmitted to the ground.

2. The power supply device of claim 1, wherein the first switch is a transistor and includes a base, an emitter, and a collector; the control microchip is electrically connected to the base to turn on and off the first switch, the emitter is grounded, and the collector is electrically connected to the second switch.

3. The power supply device of claim 2, wherein the second switch is a metal-oxide-semiconductor field-effect transistor (MOSFET) and includes a gate, a source, and a drain; the trigger is electrically connected to the gate to turn on and off the second switch, the source is electrically connected to the collector of the first switch, and the auxiliary power supply is electrically connected to the drain.

4. The power supply device of claim 3, further comprising a resistor electrically connected between the collector of the first switch and the source of the second switch, and the server system is electrically connected between the resistor and the collector of the first switch.

5. The power supply device of claim 1, wherein the main power supply supplies power to the control microchip.

6. The power supply device of claim 1, further comprising another auxiliary power supply electrically connected to the control microchip to supply power to the control microchip.

7. The power supply device of claim 1, further comprising a voltage regulating circuit electrically connected between the main power supply and the server system.
